(19) United States
(12) Patent Application Publication
(10) Pub. No.: US 2014/0029943 A1
(43) Pub. Date: Jan. 30, 2014

(54) COPLANAR ROUTING FOR OPTICAL TRANSMISSION

(71) Applicants: Sagi Varghese Mathai, Berkeley, CA (US); Michael Renne Ty Tan, Menlo Park, CA (US); Wayne Victor Sorin, Mountain View, CA (US)

(72) Inventors: Sagi Varghese Mathai, Berkeley, CA (US); Michael Renne Ty Tan, Menlo Park, CA (US); Wayne Victor Sorin, Mountain View, CA (US)

(21) Appl. No.: 13/561,751

(22) Filed: Jul. 30, 2012

(51) Int. Cl. H04J 14/02

(52) U.S. Cl. 398/49

(57) ABSTRACT

A system includes a laser array that receives a plurality of electrical signals and generates a plurality of optical signals driven from a corresponding member of the plurality of electrical signals, wherein the plurality of optical signals are arranged in a plurality of different groups. A coplanar router routes the plurality of optical signals to an array of optical multiplexers, such that each multiplexer receives optical signals from each of the plurality of different groups.

### BACKGROUND

Transmitting information via an optical domain has become the mainstay of today's data communications primarily due to a potentially large bandwidth. Accessing this wide bandwidth places demands on the devices and components used in such communications. For instance, some optical communications schemes can require three-dimensional assembly of complex optical components such as lasers and filter arrays, wherein such multi-dimensional assembly adds to overall system costs. Another communications scheme relies on monolithically integrated optical modules on a single wafer which provides challenges in performance such as limiting the number of wavelengths due to material gain bandwidth and sacrificing high temperature operation.

### BRIEF DESCRIPTION OF THE DRAWINGS

FIG. 1 illustrates an example of a system that facilitates optical data transmission via coplanar routing of optical signals.

FIG. 2 illustrates an example of a system that facilitates optical data transmission via coplanar routing of optical signals, wherein the coplanar routing is provided by an optical waveguide shuffle network.

FIG. 3 illustrates an example of a system that facilitates optical data reception via coplanar routing of optical signals, wherein the coplanar routing is provided by an optical waveguide shuffle network.

FIG. 4 illustrates an alternative example of a system that facilitates optical data reception.

FIG. 5 illustrates an example of a generalized system that facilitates optical data transmission via coplanar routing of optical signals, wherein the coplanar routing is provided by an optical waveguide shuffle network.

FIG. 6 illustrates an example of a system that facilitates optical data transmission via coplanar routing of optical signals, wherein the coplanar routing is provided by a staggered laser array configuration.

FIG. 7 illustrates an example of a system that facilitates optical data reception via coplanar routing of optical signals, wherein the coplanar routing is provided by a staggered laser array configuration.

FIG. 8 illustrates an example of a generalized system that facilitates optical data transmission via coplanar routing of optical signals, wherein the coplanar routing is provided by a staggered laser array configuration.

FIG. 9 illustrates a flowchart of an example method for transmitting optical data.

### DETAILED DESCRIPTION

An optical transmission system and method is provided where electrical signals are converted to optical frequencies that are routed along a single dimension (e.g., along the same plane) and spatially multiplexed on to a data transmissions path to increase information bandwidth while mitigating system costs. System costs can be mitigated since assembly costs can be reduced by the employment of a coplanar router that allows optical frequencies to be routed on a common signal plane while mitigating the need for multidimensional assemblies to achieve such routing. In one example, the coplanar router employs an optical waveguide shuffle network to route the optical frequencies on the common signal plane and then to optical multiplexers for efficient grouping of the optical frequencies for subsequent optical data transmission. In another example, a staggered configuration of laser arrays coupled to coplanar optical waveguides provides coplanar routing of the optical frequencies to the optical multiplexers.

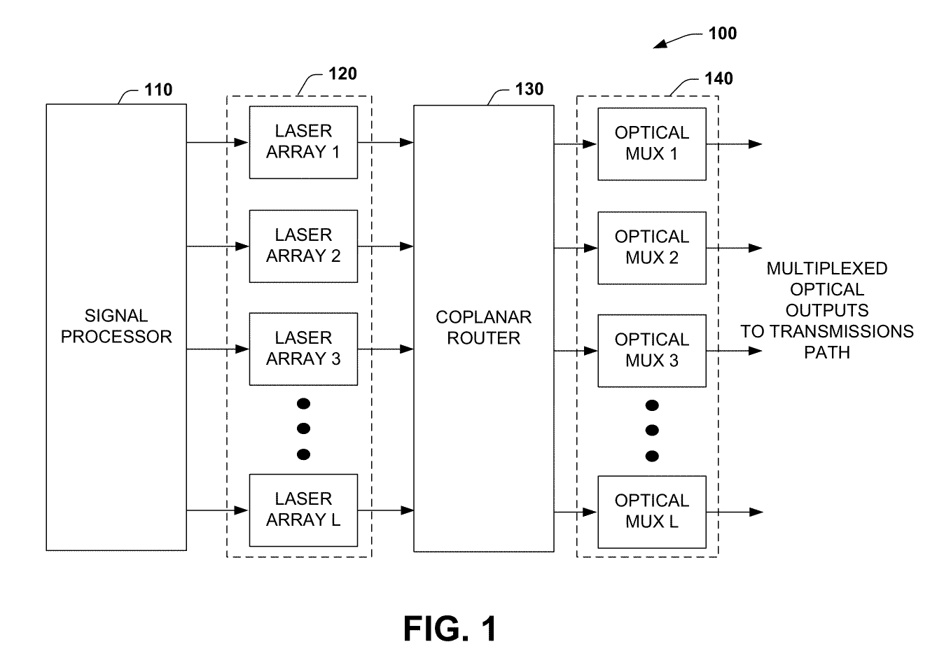

FIG. 1 illustrates an example of a system 100 that facilitates optical data transmission via coplanar routing of optical signals. As used herein, the term coplanar routing refers to routing of optical signals along a similar or common plane without also invoking other dimensions (e.g., routing from horizontal dimension to vertical dimension) to achieve desired optical signal routing for the system 100. The system 100 includes a signal processor 110 to generate a plurality of electrical signals to be transmitted. The signal processor 110 can be an embedded processor having instructions or can be an application specific integrated circuit (ASIC), for example, that generates data for communications such as within the context of an optoelectronic engine, for example. A laser array 120 (shown as Laser Array 1-L, with L being a positive integer) receives the plurality of electrical signals from the signal processor 110 and generates a plurality of optical signals driven from a corresponding member of the plurality of electrical signals, wherein the plurality of optical signals are arranged in a plurality of different groups. Thus, the laser array 120 receives electrical data at its respective input and generates optical data corresponding to the electrical data at its output, wherein such output can be communicated via the output of the laser array 120.

A coplanar router 130 routes the plurality of optical signals to an array of optical multiplexers 140, such that each multiplexer receives optical signals from each of the plurality of different groups. The array of optical multiplexers 140 (shown as Optical MUX 1-L) multiplex the optical frequencies on to a transmissions path. Thus, each multiplexed optical output is a grouping of the respective optical signals that have been routed to the optical multiplexers 140 by the coplanar router 130. Outputs from the optical multiplexers 140 can be communicated over waveguides to an optical transmissions media such as fiber optic cable, for example. As will be illustrated and described below, optical receivers can be constructed utilizing similar routing principles described herein to de-multiplex received optical data from the transmissions path and decode transmitted information received therefrom. In one example, the coplanar router 130 employs an optical shuffle network to direct optical frequencies from the laser array 120 to the optical multiplexers 140. In another example, the coplanar router 130 is provided as a staggered configuration of the laser arrays 120 to enable routing along a single plane.

With respect to the optical waveguide shuffle network example, the system 100 provides a scalable wavelength division multiplexed (WDM) optical module for parallel optical interconnects. The system 100 can include vertical cavity surface emitting laser (VCSEL) die arrays for the laser arrays 120, an optical waveguide shuffle network (OWSN) for the coplanar router 130, and an array of arrayed waveguide gratings (AWG) for the optical multiplexers 140. Each VCSEL die can have a unique wavelength (or can be composed of multiple differing wavelengths), and can be flip-chipped and coupled into the OWSN via grating couplers, for example. As used herein, flip-chip refers to a technology for microelectronic assembly that is the direct electrical connection of face-down (hence, “flipped”) electronic and optoelectronic components onto substrates, circuit boards, or carriers, by means of conductive bumps on the chip bond pads. In contrast, wire bonding, the older technology which flip-chip may be replacing, uses face-up chips with a wire connection to each pad. Flip-chip is also referred to as Direct Chip Attach (DCA), a more descriptive term, since the chip is directly attached to the substrate, board, or carrier by the conductive bumps.

The OWSN can route 1 wavelength per VCSEL die to each AWG in one example. The AWGs multiplex the WDM signals into a set of parallel optical waveguides which can be coupled to an optical fiber array using grating couplers for data transmission along the transmissions path. Alternatively, the set of parallel optical waveguides can be butt-coupled to the optical fiber array or imaged onto the optical fiber array using micro-lenses. The system 100 can take advantage of high yield optical sources, flip-chip assembly, monolithic integration of photonic integrated circuits, and the option for on-wafer testing to achieve a low cost WDM optoelectronic (OE) engine. By replacing the VCSELs with photo-detectors, this system 100 can function as a WDM receiver. The OWSN mitigates the need for monolithically integrated multi-wavelength VCSEL arrays and enables the use of optimized discrete wavelength VCSEL wafers, for example. The optical waveguide shuffle network can be formed on a substrate material. In one example, the OWSN can include at least some non-parallel waveguides between parallel waveguides on either side of the waveguide shuffle network. The OWSN can include at least two intersecting optical waveguides which intersect to form a low loss junction, for example, and to facilitate routing of optical signals.

With respect to the staggered laser array configuration for coplanar routing of optical signals, a scalable wavelength division multiplexed (WDM) optoelectronic engine (OE) can be supported for parallel optical interconnects. Parallel optical waveguides transport individual WDM signals from a set of vertical cavity surface emitting lasers (VCSELs) to an arrayed waveguide grating (AWG). Each VCSEL die can include a 1×N array of optical sources emitting a unique optical wavelength (or different optical wavelengths). The VCSEL dies can be flip-chip self-aligned to grating couplers at the inputs of each waveguide. Each die can be staggered along the parallel optical waveguides to route 1 wavelength per VCSEL die to a set of arrayed waveguide gratings (AWG). The AWGs can multiplex the WDM signals onto a set of output optical waveguides which can be coupled to 1D or 2D optical fiber arrays using gratings couplers. The number of wavelengths can be scaled by increasing the number of unique wavelength dies, parallel optical waveguides, and free spectral range of the AWG. The staggered optoelectronic die arrangement for the laser array 120 simplifies the overall layout of the planar light wave circuit and provides an architecture that can be scaled in wavelength, and therefore, aggregate bandwidth.

For purposes of simplification of explanation, in the example of FIG. 1, different components of the system 100 are illustrated and described as performing different functions. However, one of ordinary skill in the art will understand and appreciate that the functions of the described components can be performed by different components, and the functionality of several components can be combined and executed on a single component.

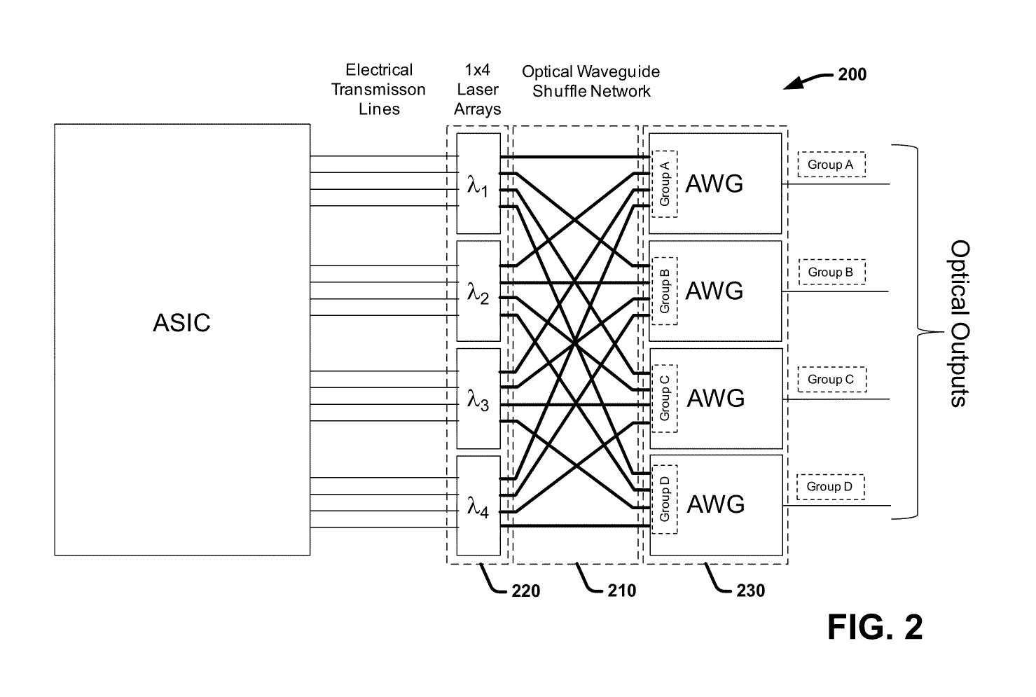

FIG. 2 illustrates an example of a system 200 that facilitates optical data transmission via coplanar routing of optical signals, wherein the coplanar routing is provided by an optical waveguide shuffle network. An optical waveguide shuffle network 210 (OWSN) routes wavelengths from discrete wavelength vertical cavity surface emitting laser (VCSEL) dies 220 to an array of arrayed waveguide gratings (AWGs) 230. For example, four 1×4 VCSEL dies are shown however other configurations are possible (e.g., 3 VCSEL, 8 VCSEL). Each die at 220 emits a unique optical wavelength (lambda_{—}1, lambda_{—}2, lambda_{—}3, or lambda_{—}4). Grating couplers are used to couple the light from the VCSEL dies 220 to the array of optical waveguides. The optical waveguides comprise the OWSN 210 whose function is to “shuffle” or route a set of four discrete wavelengths from each VCSEL die to an AWG 230. The AWG multiplexes the 4 discrete wavelengths onto a single optical waveguide. The 4 AWGs shown in this example are substantially identical and multiplex 4 sets of 4 wavelength channels onto 4 output waveguides. The waveguides can be coupled to 1×4 fiber ribbon or multi-core fibers using grating couplers, for example.

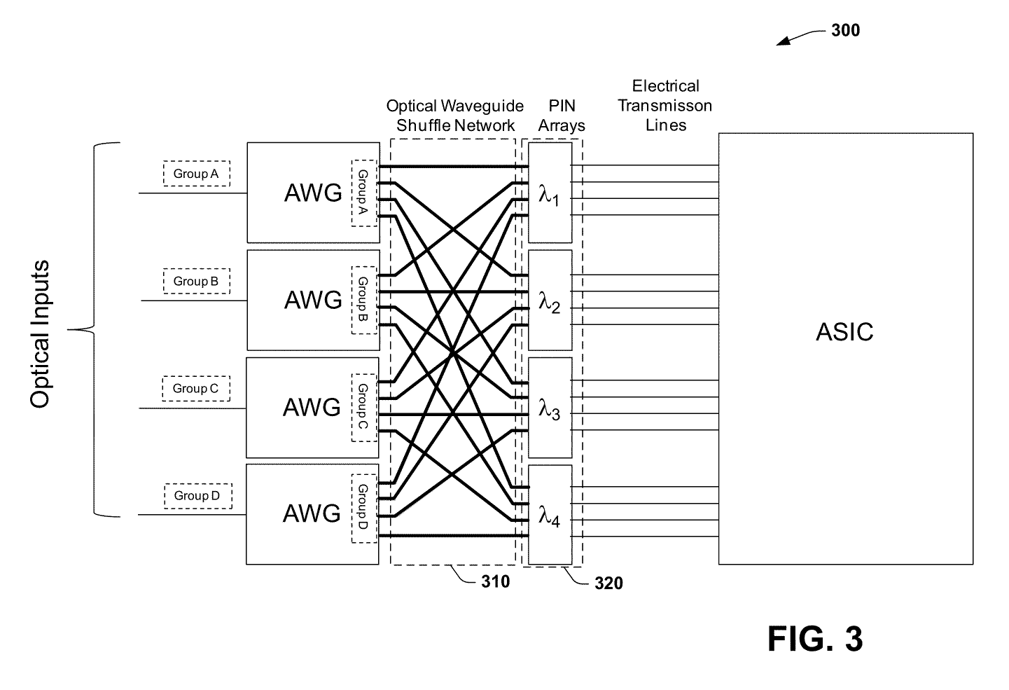

FIG. 3 illustrates an example of a system 300 that facilitates optical data reception via coplanar routing of optical signals, wherein the coplanar routing is provided by an optical waveguide shuffle network 310. Operated in reverse of the system 200 depicted in FIG. 2, and replacing the VCSEL dies with photo-detector dies 320, the system 300 can behave as a wavelength de-multiplexer to enable a complementary WDM receiver.

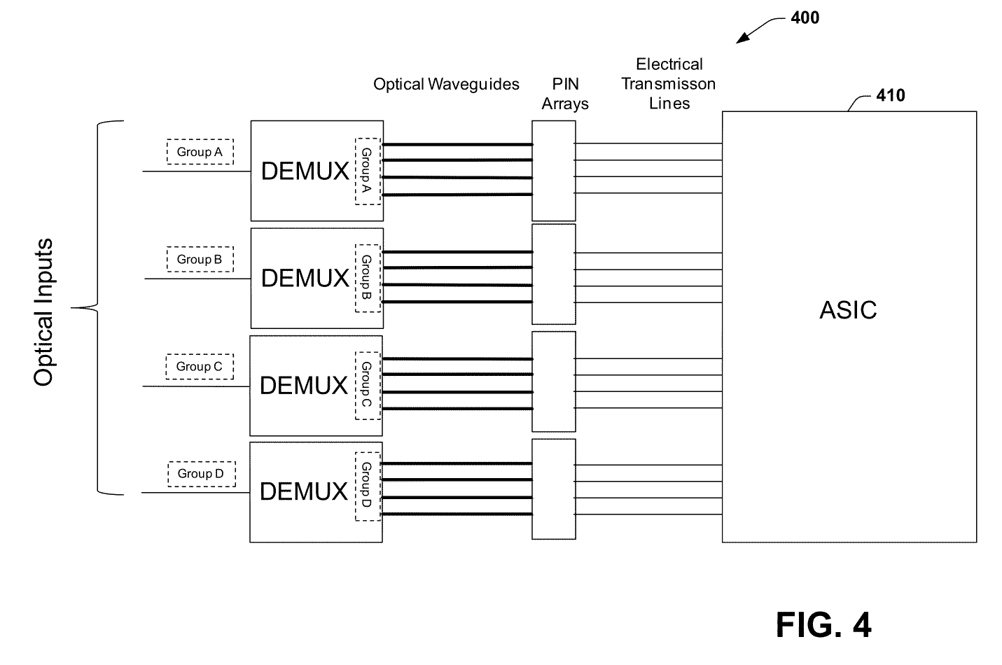

FIG. 4 illustrates an alternative example of a system 400 that facilitates optical data reception. In this example, rather than de-shuffling shuffled data from the respective optical transmitter that may have employed an optical waveguide shuffle network for signal routing, the system 400 configures an ASIC 410 such that de-shuffling and/or decoding of the received optical inputs that have been converted to electrical signals are organized for further data processing. Such decoding could be based on received header information in the optical data stream indicating the decoding pattern to be employed by the ASIC 410. In another example, de-shuffling/decoding could be performed by re-routing the electrical traces to the ASIC 410. As shown, signals can be routed straight through to the ASIC 410 where either electrical signal routing and/or ASIC decoding can be employed to process information derived from the received optical data.

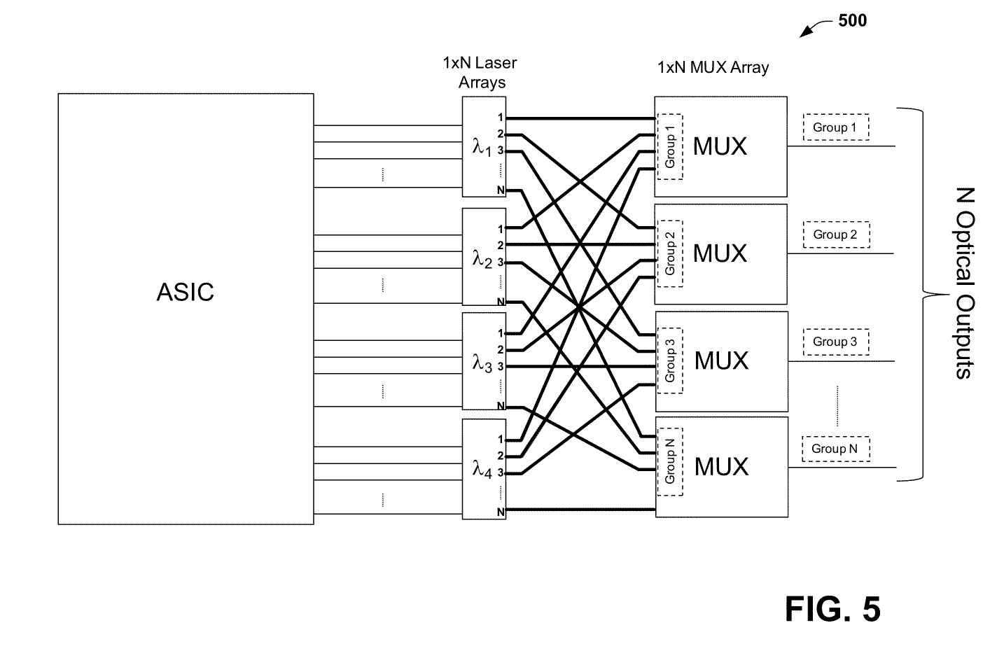

FIG. 5 illustrates an example of a generalized system 500 that facilitates optical data transmission via coplanar routing of optical signals, wherein the coplanar routing is provided by an optical waveguide shuffle network. In this example, the system 500 is generalized to 2D (or M×N) laser arrays. This configuration can employ integration of 1D array of M×N optical waveguides, 1D array of M×N MUX's, and 1D array of M×N optical output waveguides coupled to 1D array of M×N optical fiber arrays. The output optical waveguides may be arranged to couple to 1× (M×N) fiber arrays or M×N fiber arrays, in general. To illustrate the example, wavelengths or laser dies are specified by the positive integer W=4 in this example. The number of rows of lasers per die is specified as M=1 in this example. A variable N=12 is number of columns of lasers per die. Thus, the number of lasers per die is M*N=12 in this example. The quantity W*M*N=48 is the number of electrical signals in this example which also equals the number of optical waveguides employed at the output of the VCSEL arrays, for example. The number of MUX is M*N=12 in this example, wherein M*N is also the number of optical outputs to be utilized. W, M, and N can be set to various integer values to describe a plurality of differing transmitter configurations.

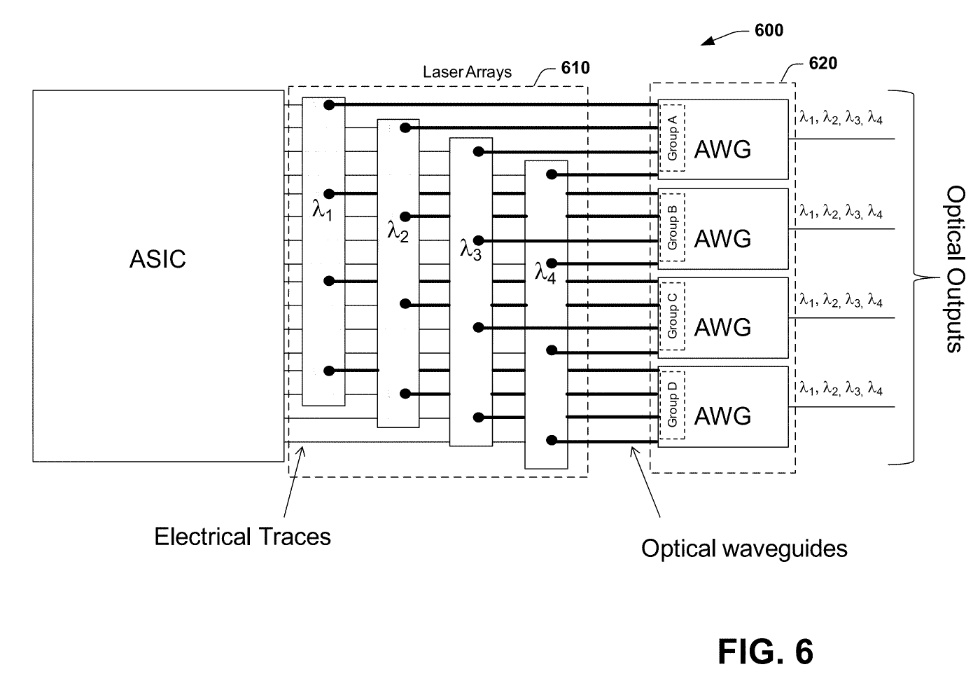

FIG. 6 illustrates an example of a system 600 that facilitates optical data transmission via coplanar routing of optical signals, wherein the coplanar routing is provided by a staggered laser array configuration coupled to coplanar optical waveguides. The system 600 includes a parallel array of optical waveguides to transport wavelengths from discrete wavelength VCSEL dies 610 to a set of AWGs 620. For example, four 1×4 VCSEL dies 610 are shown. Each die can emit a unique optical wavelength (lambda_{—}1, lambda_{—}2, lambda_{—}3, lambda_{—}4). Grating couplers are used to couple the VCSEL dies 610 to an array of optical waveguides. The waveguides may be grouped in sets of 4 waveguides each in this example. The VCSEL dies 610 are staggered such that the waveguides in a group transports lambda_{—}1, lambda_{—}2, lambda_{—}3 and lambda_{—}4, respectively. Each waveguide group (A, B, C, D) feeds its own AWG 620. Each AWG 620 is substantially identical and multiplexes the 4 wavelengths onto a single output waveguide. The output waveguides can be coupled to 1×4 fiber ribbon or multi-core fibers using grating couplers.

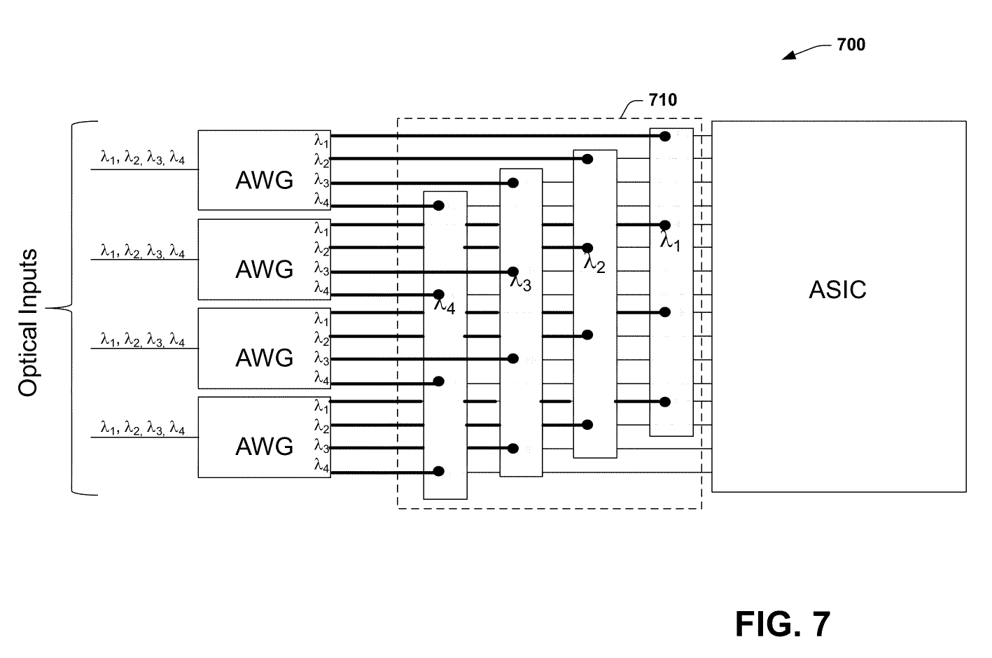

FIG. 7 illustrates an example of a system that facilitates optical data reception via coplanar routing of optical signals, wherein the coplanar routing is provided by a staggered laser array configuration coupled to coplanar optical waveguides. Operated in reverse of the system depicted in FIG. 6, and replacing the VCSEL dies with photo-detector dies 710, the system 600 described above can behave as a wavelength de-multiplexer to enable a complementary WDM receiver. With respect to any of the coplanar receiver configurations depicted in FIGS. 3, 4, and 7, a single 1×N or M×N photodetector die can be employed to receive all wavelength channels. In another receiver example, different photodetector technologies can be employed to optimize the responsivity for a particular wavelength. For example, 850 nm and 1550 nm wavelength optical signals are typically detected utilizing GaAs and InP substrate based photodetectors, respectively.

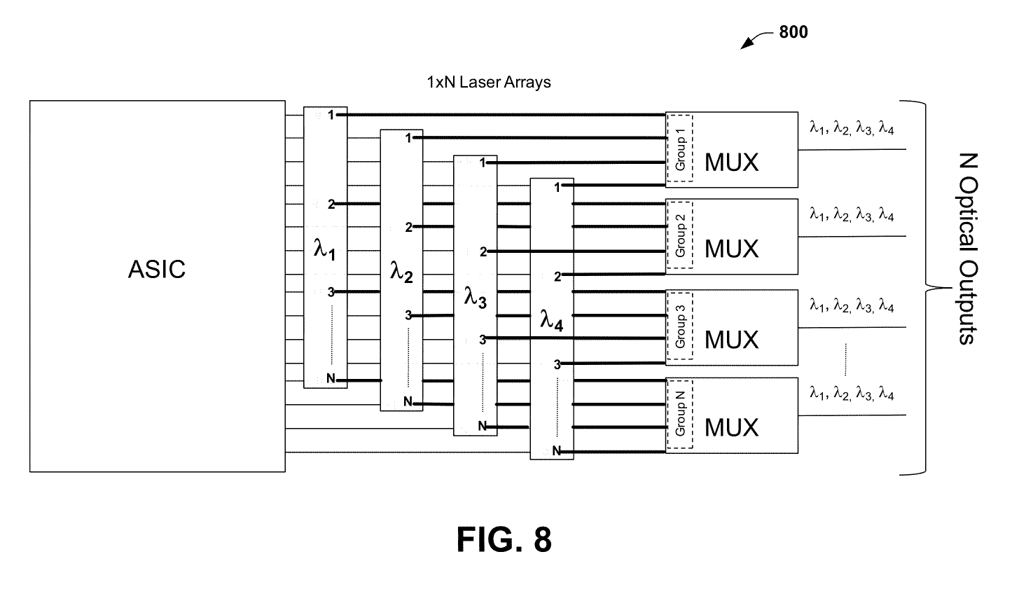

FIG. 8 illustrates an example of a generalized system 800 that facilitates optical data transmission via coplanar routing of optical signals, wherein the coplanar routing is provided by a staggered laser array configuration coupled to coplanar optical waveguides. The system 600 described above can be generalized to 2D (or M×N) laser arrays and W wavelengths. This will utilize integration of W×M×N optical waveguides, M×N MUX's, and array of M×N optical output waveguides coupled to array of M×N optical fibers. The output optical waveguides may be arranged to couple to 1× (M×N) fiber arrays or M×N fiber arrays, in general. The variables M, N, and W were described in an example above with respect to FIG. 5.

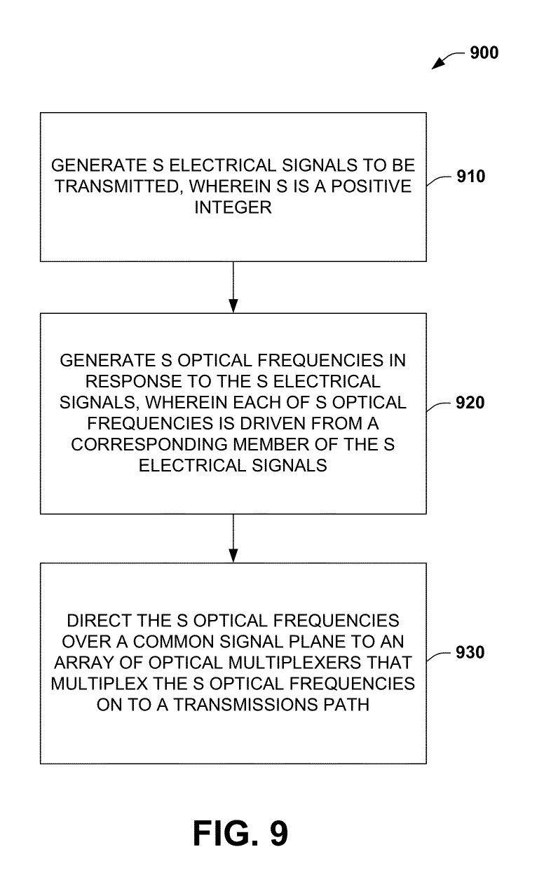

In view of the foregoing structural and functional features described above, an example method will be better appreciated with reference to FIG. 9. While, for purposes of simplicity of explanation, the example method of FIG. 9 is shown and described as executing serially, it is to be understood and appreciated that the present examples are not limited by the illustrated order, as some actions could in other examples occur in different orders and/or concurrently from that shown and described herein. Moreover, it is not necessary that all described actions be performed to implement a method.

FIG. 9 illustrates a flowchart of an example method 900 for transmitting optical data. At 910, the method 900 includes generating a plurality of electrical signals to be transmitted. In one example, a signal processor, ASIC, or integrated microprocessor with embedded firmware can be employed to generate the plurality of electrical signals. At 920, the method 900 includes generating a plurality of optical signals from a corresponding member of the plurality of electrical signals to be transmitted, wherein the plurality of optical signals are arranged in a plurality of different groups. In one example, the plurality of optical signals can be generated from a laser array such as an array of vertical cavity surface emitting lasers (VCSEL). At 930, the method 900 includes routing the plurality of optical signals to an array of optical multiplexers, such that each multiplexer receives optical signals from each of the plurality of different groups. This can include utilizing a coplanar router to direct the plurality of optical signals over the common signal plane to the array of optical multiplexers. In one example, the coplanar router can be an optical waveguide shuffle network (OSWG). In another example, the coplanar router can be a staggered configuration of laser arrays coupled to coplanar optical waveguides.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a laser array that receives a plurality of electrical signals and generates a plurality of optical signals driven from a corresponding member of the plurality of electrical signals, wherein the plurality of optical signals are arranged in a plurality of different groups; and
a coplanar router to route the plurality of optical signals to an array of optical multiplexers, such that each multiplexer receives optical signals from each of the plurality of different groups.

2. The system of claim 1, wherein each group arranged in the plurality of different groups operate at a different optical frequency.

3. The system of claim 1, wherein each signal in the plurality of optical signals is a different optical frequency.

4. The system of claim 1, wherein the coplanar router employs an optical waveguide shuffle network (OWSN) to direct the optical signals to the array of optical multiplexers.

5. The system of claim 1, wherein the coplanar router is a staggered configuration of laser dies in the laser array coupled to coplanar optical waveguides to direct the optical signals to the array of optical multiplexers.

6. The system of claim 1, further comprising a wavelength division multiplexed (WDM) receiver to de-multiplex the multiplexed optical frequencies from the transmissions path and decode information from the de-multiplexed optical frequencies.

7. The system of claim 6, wherein the optical receiver employs a coplanar router that includes an optical waveguide shuffle network, an electrical signal routing pattern, or a decoding algorithm by a signal processor to de-multiplex optical data received from the transmissions path.

8. The system of claim 7, wherein the optical receiver employs a photo-detector array and a coplanar router to receive optical data from the transmissions path.

9. The system of claim 1, wherein the laser array is a vertical cavity surface emitting laser (VCSEL).

10. The system of claim 1, wherein the laser array employs wavelength division multiplexing (WDM) to transmit the plurality of optical signals.

11. A method comprising:
generating a plurality of electrical signals to be transmitted;
generating a plurality of optical signals from a corresponding member of the plurality of electrical signals to be transmitted, wherein the plurality of optical signals are arranged in a plurality of different groups; and
routing the plurality of optical signals to an array of optical multiplexers, such that each multiplexer receives optical signals from each of the plurality of different groups.

12. The method of claim 11, further comprising utilizing a coplanar router to route the plurality of optical signals over a common plane to the array of optical multiplexers.

13. A system, comprising:
an application specific integrated circuit (ASIC) to generate a plurality of electrical signals to be transmitted;
a vertical cavity surface emitting lasers (VCSEL) that receives the plurality of electrical signals to be transmitted and generates a plurality of optical signals driven from a corresponding member of the plurality of electrical signals, wherein the plurality of optical signals are arranged in a plurality of different groups; and
a coplanar router to route the plurality of optical signals to an array of optical multiplexers, such that each multiplexer receives optical signals from each of the plurality of different groups.

14. The system of claim 13, wherein the coplanar router is an optical waveguide shuffle network (OWSN) or a staggered configuration of laser arrays coupled to coplanar optical waveguides.

15. The system of claim 13, further comprising an optical receiver to receive the multiplexed optical signals from a transmissions path.
